(19) United States
(12) Patent Application Publication
(10) Pub. No.: US 2022/0289215 A1
(43) Pub. Date: Sep. 15, 2022

(54) DRIVING DIAGNOSIS DEVICE, DRIVING DIAGNOSIS SYSTEM AND DRIVING DIAGNOSIS METHOD

(71) Applicant: Toyota Jidosha Kabushiki Kaisha, Toyota-shi Aichi-ken (JP)

(72) Inventors: Yasuyuki Kamezaki, Toyota-shi Aichi-ken (JP); Shuhei Manabe, Toyota-shi Aichi-ken (JP); Takaaki Nagatani, Okazaki-shi Aichi-ken (JP); Masato Endo, Nagoya-shi Aichi-ken (JP)

(21) Appl. No.: 17/566,072

(22) Filed: Dec. 30, 2021

(30) Foreign Application Priority Data
Mar. 10, 2021 (JP) 2021-038773

(51) Int. Cl. B60W 50/02; B60W 50/14; B60W 40/08

(52) U.S. Cl. CPC B60W 50/0205; B60W 50/14; B60W 40/08

(57) ABSTRACT

A driving diagnosis device acquires at least one of vehicle information regarding a vehicle state and driving information regarding a driving state of the driver, and measures the number of times each of conditions of preset evaluation items related to driving is met, based on the acquired vehicle information and the acquired driving information. Then, the driving diagnosis device outputs warning information when the number of measurement times of the evaluation items reaches a predetermined warning number corresponding to the one of the evaluation items. Further, the driving diagnosis device performs advance notification to the driver when a predetermined notification condition is satisfied before the number of measurement times reaches the warning number.

### CROSS-REFERENCE TO RELATED APPLICATION

This application claims priority to Japanese Patent Application No. 2021-038773 filed on Mar. 10, 2021, incorporated herein by reference in its entirety.

### BACKGROUND

### 1. Technical Field

The present disclosure relates to a driving diagnosis device, a driving diagnosis system, and a driving diagnosis method.

### 2. Description of Related Art

Japanese Unexamined Patent Application Publication No. 2014-071621 (JP 2014-071621 A) discloses a driving diagnosis management system that measures the number of times the driver's driving content deviates from at least one of safe driving and fuel-efficient driving as the number of violations, and that transmits the number of violations when the number of violations exceeds a threshold value.

### SUMMARY

However, in the above-mentioned JP 2014-071621 A, the number of violations is transmitted to the management terminal only when the number of violations reaches the number required for a warning. Therefore, the driver cannot grasp the information on the number of violations in advance, and there is room for improvement from the viewpoint of effectively promoting the improvement of driving.

An object of the present disclosure is to acquire a driving diagnosis device, a driving diagnosis system, and a driving diagnosis method that can effectively encourage a driver to improve driving.

A first aspect of the disclosure relates to a driving diagnosis device. The driving diagnosis device includes: an acquisition unit that acquires at least one of vehicle information regarding a vehicle state and driving information regarding a driving state of a driver; a measuring unit that measures the number of times each of conditions of preset evaluation items related to driving is met, based on the acquired vehicle information and the acquired driving information; a warning unit that outputs warning information when the number of measurement times of one of the evaluation items reaches a predetermined warning number corresponding to the one of the evaluation items; and an advance notification unit that performs advance notification to the driver when a predetermined notification condition is satisfied before the number of measurement times reaches the warning number.

According to the first aspect, the acquisition unit acquires at least one of the vehicle information and the driving information. Further, the measuring unit measures the number of times each of the conditions of the preset evaluation items related to driving is met, based on the vehicle information and the driving information acquired by the acquisition unit. Then, when the number of measurement times of one of the evaluation items reaches the predetermined warning number corresponding to the one of the evaluation items, the warning information is output by the warning unit. As a result, it is possible to grasp the evaluation item in which improvement in driving needs to be performed by referring to the warning information.

Further, when a predetermined notification condition is satisfied before the number of measurement times reaches the warning number, the advance notification unit notifies the driver in advance. As a result, the driver can know the information on the number of measurement times before the number of measurement times reaches the warning number, and it is possible to promote the improvement of driving before the number of measurement times reaches the warning number.

In the driving diagnosis of the first aspect, the notification condition may include a case in which the number of measurement times reaches a predetermined caution number that is less than the warning number by a predetermined number of times.

In the driving diagnosis device according the above aspect, the driver is notified when the number of measurement times reaches the caution number. This makes it possible for the driver to know the number of times it takes to reach the warning number.

In the driving diagnosis device of the above aspect, the notification condition may include a case in which a predetermined time comes before the number of measurement times reaches the caution number

In the driving diagnosis device according to the above aspect, even in a state before the number of measurement times reaches the caution number, the driver can grasp the driving situation by being notified of the predetermined time.

In the driving diagnosis device according the above aspect, the notification condition may include a case in which a predetermined traveling distance is reached before the number of measurement times reaches the caution number.

In the driving diagnosis device according to the above aspect, even in a state before the number of measurement times reaches the caution number, the driver can grasp the driving situation by being notified when the predetermined traveling distance is reached.

In the driving diagnosis device according to the above aspect, the advance notification unit may perform advance notification only for a specific evaluation item among the evaluation items.

In the driving diagnosis device according to the above aspect, advance notification is given only for a specific evaluation item, among the plurality of the evaluation items. Thus, compared to when advance notification is given to all of the evaluation items, it is possible to suppress the driver from feeling annoyed.

A second aspect of the disclosure relates to a driving diagnosis system. The system includes: a server owned by a manager of a vehicle; a notification device installed in the vehicle; and the driving diagnosis device of the first aspect, in which the warning unit outputs warning information to the server, and in which the advance notification unit performs advance notification to a driver by the notification device.

In the driving diagnosis system according to the second aspect, the warning information is output to the server of the manager by the warning unit. Thus, the manager can centrally manage the warning information. Further, the advance notification unit performs advance notification to the driver with the notification device provided in the vehicle and thus, the driver can be effectively notified.

A third aspect of the disclosure relates to a driving diagnosis method. The method includes: acquiring at least one of vehicle information regarding a vehicle state and driving information regarding a driving state of a driver; measuring the number of times each of conditions of preset evaluation items related to driving is met, based on the acquired vehicle information and the acquired driving information; outputting warning information when the number of measurement times of one of the evaluation items reaches a predetermined warning number corresponding to the one of the evaluation items; and performing advance notification to the driver when a predetermined notification condition is satisfied before the number of measurement times reaches the warning number.

As described above, the driving diagnosis device, the driving diagnosis system, and the driving diagnosis method according to the present disclosure can effectively encourage the driver to make an improvement in driving.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view showing an overall configuration of a driving diagnosis system according to an embodiment;

FIG. 2 is a block diagram showing a hardware configuration of a driving diagnosis device according to the embodiment;

FIG. 3 is a block diagram showing a hardware configuration of a server according to the embodiment;

FIG. 4 is a block diagram showing a functional configuration of the driving diagnosis device according to the embodiment;

FIG. 5 is a table showing an example of evaluation items in the embodiment;

FIG. 6 is a flowchart showing an example of a flow of a driving diagnosis process in the embodiment;

FIG. 7 is a flowchart showing an example of a flow of an advance notification process in the embodiment; and

FIG. 8 is a flowchart showing another example of the flow of the advance notification process in the embodiment.

### DETAILED DESCRIPTION OF EMBODIMENTS

A driving diagnosis system 10 including a driving diagnosis device 12 according to the embodiment will be described with reference to the drawings.

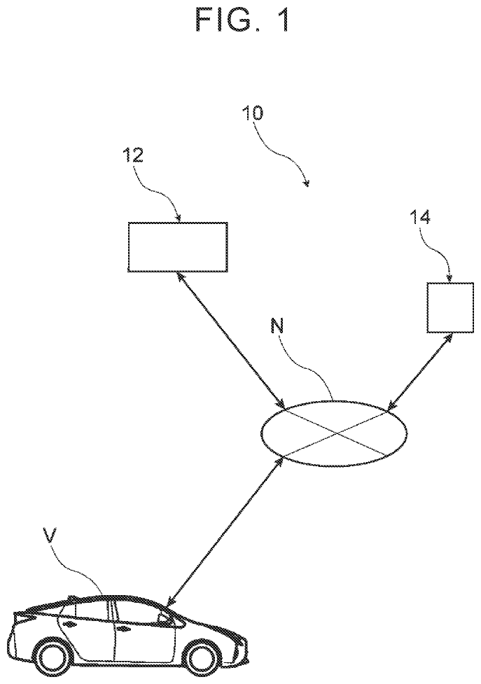

As shown in FIG. 1, the driving diagnosis system 10 of the present embodiment includes the driving diagnosis device 12, a server 14, and a vehicle V. The driving diagnosis device 12, the server 14, and the vehicle V are connected by a network N. Although a plurality of vehicles V are connected to the network N, only one vehicle V is shown in FIG. 1 for convenience of explanation.

As an example, the driving diagnosis device 12 of the present embodiment is an on-board device mounted on the vehicle V. However, the driving diagnosis device 12 is not limited to this. For example, the driving diagnosis device 12 may be a control device provided outside the vehicle V.

The server 14 is a server owned by a manager of the vehicles V. That is, the manager who manages the vehicles V owns the server 14, and as an example in the present embodiment, the vehicle V is a vehicle used as a taxi that carries a user. The server 14 is owned by a taxi company.

Here, the driving diagnosis device 12 of the present embodiment performs a driving diagnosis of the driver that drives each vehicle V, and cautions or warns the driver based on a driving diagnosis result.

Hardware Configuration of Driving Diagnosis Device 12

FIG. 2 is a block diagram showing a hardware configuration of the driving diagnosis device 12. As shown in FIG. 1, the driving diagnosis device 12 is configured to include a central processing unit (CPU: processor) 20, a read only memory (ROM) 22, a random access memory (RAM) 24, a storage 26, a communication interface 28, and an input-output interface 30. Each configuration is communicably connected to each other via a bus 32.

The CPU 20 is a central processing unit that executes various programs and that controls various units. That is, the CPU 20 reads the program from the ROM 22 or the storage 26 and executes the program using the RAM 24 as a work area. The CPU 20 controls each of the above configurations and performs various arithmetic processes in accordance with the program recorded in the ROM 22 or the storage 26.

The ROM 22 stores various programs and various data. The RAM 24 temporarily stores a program or data as a work area. The storage 26 is composed of a hard disk drive (HDD) or a solid state drive (SSD), stores various programs including an operating system, and stores various data. In the present embodiment, the ROM 22 or the storage 26 stores a program for performing a driving diagnosis process, a program for performing an advance notification process, various data, and the like.

The communication interface 28 is an interface for the driving diagnosis device 12 to communicate with a server and other devices (not shown), and for example, standards such as a controller area network (CAN), Ethernet (registered trademark), long term evolution (LTE), fiber distributed data interface (FDDI), and Wi-Fi (registered trademark) are used.

A front camera 40, an indoor camera 42, an acceleration sensor 44, a steering angle sensor 46, a center display 48 serving as a notification device, and a speaker 50 serving as a notification device are electrically connected to the input-output interface 30.

The front camera 40 is provided at a front part of the vehicle and captures an image of what is ahead of the vehicle. The image captured by the front camera 40 is used, for example, to recognize an inter-vehicle distance between the vehicle V and a preceding vehicle that is traveling in front of the vehicle V, a lane, a traffic light, and the like.

The indoor camera 42 is provided in a vehicle cabin of the vehicle V and is directed toward the driver. Then, the image captured by the indoor camera 42 is used, for example, to detect a line-of-sight direction of the driver.

The acceleration sensor 44 detects an acceleration of the vehicle. The steering angle sensor 46 detects a steering angle of the vehicle. The acceleration data detected by the acceleration sensor 44 is used, for example, to determine whether the vehicle V is suddenly accelerated or decelerated. Further, the steering angle data detected by the steering angle sensor 46 is used, for example, to determine whether a sudden steering or a U-turn is performed.

The center display 48 is provided, for example, at a position visible from the driver in a front part of the vehicle cabin, and various information is displayed. Further, the center display 48 displays the content of an advance notification described later. The speaker 50 is provided in the vehicle cabin and outputs sound to the driver.

Hardware Configuration of Server 14

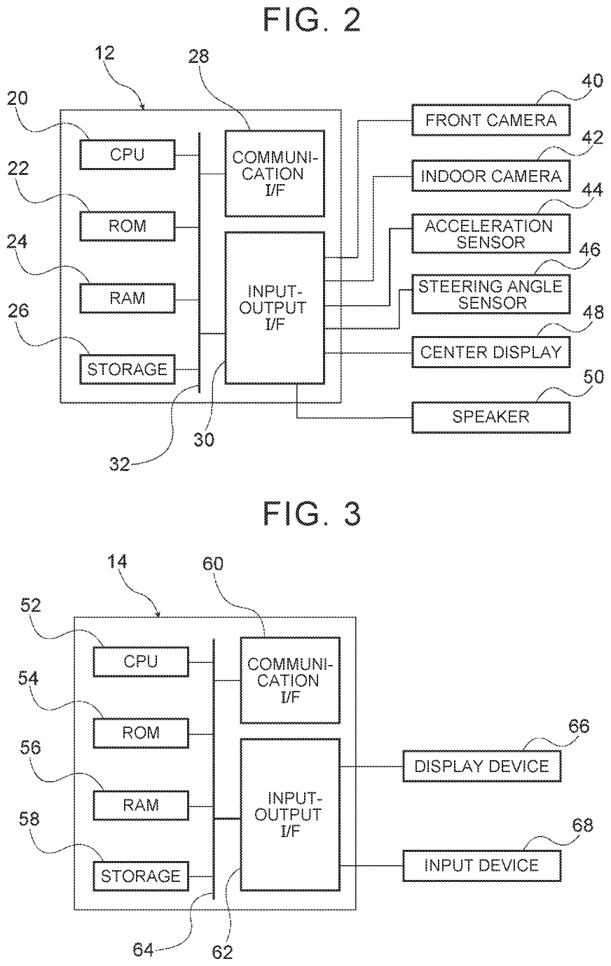

FIG. 3 is a block diagram showing a hardware configuration of the server 14. As shown in FIG. 3, the server 14 includes a CPU 52, a ROM 54, a RAM 56, a storage 58, a communication interface 60, and an input-output interface 62. Each configuration is communicably connected to each other via a bus 64.

The CPU 52 is a central processing unit that executes various programs and that controls various units. That is, the CPU 52 reads the program from the ROM 54 or the storage 58 and executes the program using the RAM 56 as a work area. The CPU 52 controls each of the above configurations and performs various arithmetic processes in accordance with the program recorded in the ROM 54 or the storage 58.

The ROM 54 stores various programs and various data. The RAM 56 temporarily stores a program or data as a work area. The storage 58 is composed of an HDD or an SSD, stores various programs including an operating system, and stores various data. In the present embodiment, the ROM 54 or the storage 58 stores a program for managing the vehicles V, various data, and the like.

The communication interface 60 is an interface for the server 14 to communicate with a device such as the driving diagnosis device 12.

A display device 66 and an input device 68 are electrically connected to the input-output interface 62. The display device 66 is a monitor for displaying various information acquired by the server 14. The input device 68 is a device for the manager to input an instruction to the server 14 in order to acquire necessary information, and is, for example, a keyboard and a mouse.

Functional Configuration of Driving Diagnosis Device 12

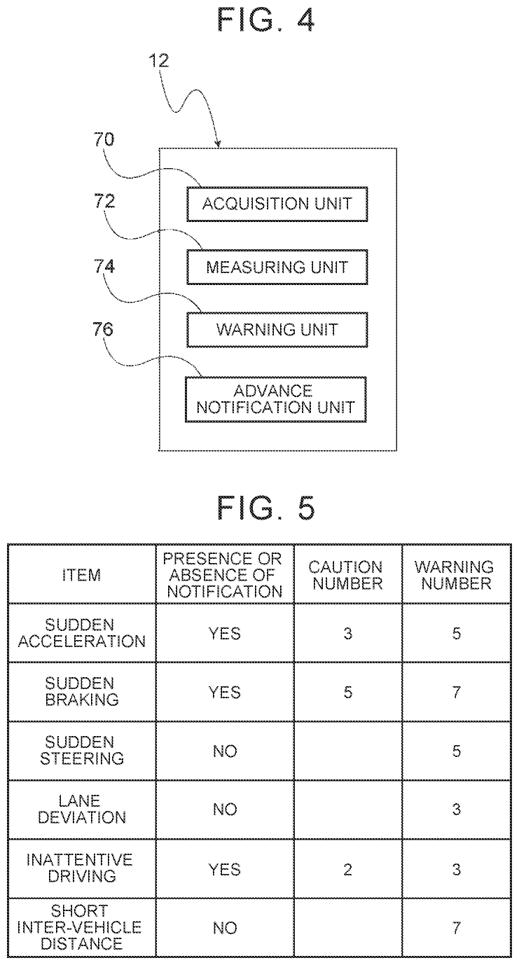

The driving diagnosis device 12 realizes various functions by using the above hardware resources. The functional configuration realized by the driving diagnosis device 12 will be described with reference to FIG. 4.

As shown in FIG. 4, the driving diagnosis device 12 includes an acquisition unit 70, a measuring unit 72, a warning unit 74, and an advance notification unit 76 as functional configurations. Each functional configuration is realized by the CPU 20 reading and executing the program stored in the ROM 22 or the storage 26.

The acquisition unit 70 acquires at least one of vehicle information regarding a vehicle state and driving information regarding a driving state of the driver. As an example, the acquisition unit 70 of the present embodiment acquires both the vehicle information and the driving information. Specifically, the acquisition unit 70 acquires an acceleration and a steering angle of the vehicle V detected by the acceleration sensor 44 and the steering angle sensor 46 as the vehicle information. Further, the acquisition unit 70 acquires, as the driving information, the inter-vehicle distance between the vehicle V and the preceding vehicle based on the image captured by the front camera 40, the traveling position with respect to the lane, and the like. Further, the acquisition unit 70 acquires the driver's line-of-sight direction from the driver's image captured by the indoor camera 42 as driving information.

Based on the acquired vehicle information and driving information, the measuring unit 72 measures the number of times conditions of preset evaluation items related to driving are met. Here, an example of the evaluation items will be described with reference to FIG. 5. In the present embodiment, the evaluation items include items of sudden acceleration, sudden braking, sudden steering, lane deviation, inattentive driving, and inter-vehicle distance. Further, the data shown in FIG. 5 is stored in the RAM 24 or the storage 26 and can be updated as appropriate.

Sudden acceleration and sudden braking are determined based on a signal from the acceleration sensor 44. For example, when the acceleration sensor 44 detects an acceleration of a predetermined value or more, the measuring unit 72 counts this as sudden acceleration. Further, when the amount of change in speed per unit time detected by the speed sensor is equal to or more than a predetermined value, the measuring unit 72 may count this as sudden acceleration. Sudden steering is determined based on a signal from the steering angle sensor 46. For example, when the amount of change in the steering angle per unit time is equal to or more than a predetermined value, the measuring unit 72 counts this as sudden steering.

Regarding lane deviation, it is determined that the vehicle V has performed lane deviation when the position of the vehicle V is deviated from the image of the view ahead of the vehicle captured by the front camera 40. For example, when the vehicle V is traveling while deviating from the lane for a predetermined time or more, the measuring unit 72 counts this as lane deviation.

Inattentive driving is measured when the driver is traveling while looking away from the traveling direction. For example, based on a signal from the indoor camera 42, when the line-of-sight direction of the driver deviates from the traveling direction for a predetermined time or more, the measuring unit 72 counts this as inattentive driving. The evaluation item indicated “short inter-vehicle distance” is an evaluation item of when the inter-vehicle distance between the vehicle V and the preceding vehicle is equal to or less than a predetermined distance based on a signal from the front camera 40 or a sensor (not shown). For example, when the state in which the inter-vehicle distance between the vehicle V and the preceding vehicle is short continues for a predetermined time or more, the measuring unit 72 counts this as a state in which the inter-vehicle distance is short.

The warning unit 74 shown in FIG. 4 outputs warning information when the number of times one of evaluation items is measured reaches a predetermined warning number corresponding to one of the evaluation items. As shown in FIG. 5, the warning number is set for each evaluation item. In this embodiment, as an example, the warning number for sudden acceleration is set to five. Therefore, the warning unit 74 outputs the warning information when the number of times sudden acceleration is measured reaches five within a predetermined period. The warning unit 74 of the present embodiment transmits the warning information to the server 14. Further, the warning information includes information for identifying the driver or the vehicle V, evaluation items in which the warning number has been reached, and information such as the time at which the warning number has been reached.

The advance notification unit 76 shown in FIG. 4 performs advance notification to the driver when a predetermined notification condition is satisfied before the number of measurement times reaches the warning number. As shown in FIG. 5, in the present embodiment, when a caution number that is a predetermined number of times less than the warning number is reached, the driver is notified in advance.

Here, in each evaluation item, a parameter of the presence or absence of the notification that determines whether to notify the driver is set. Thus, the driver is notified of the evaluation items in which the notification is turned on, and the driver is not notified of the evaluation items that are set to not issue a notification. That is, in the present embodiment, the notification is performed only to specific evaluation items among the plurality of evaluation items.

For example, in FIG. 5, the caution number for sudden acceleration is set to three. Therefore, when the number of times sudden acceleration is measured reaches three, the driver is notified. The advance notification unit 76 notifies the driver by displaying the information on the center display 48. For example, the advance notification unit 76 causes the center display 48 to display information indicating that the warning information will be output when sudden acceleration is measured two more times. Further, the advance notification unit 76 may use the speaker 50 to perform advance notification to the driver by voice. Note that the driver is not notified of the evaluation items for which a parameter to not issue a notification is set.

The advance notification unit 76 may notify the driver when a predetermined time is reached before the number of measurement times reaches the caution number. Further, the advance notification unit 76 may notify the driver when a predetermined traveling distance is reached before the number of measurement times reaches the caution number.

Effect

Next, the effect of the present embodiment will be described.

Example of Driving Diagnosis Process

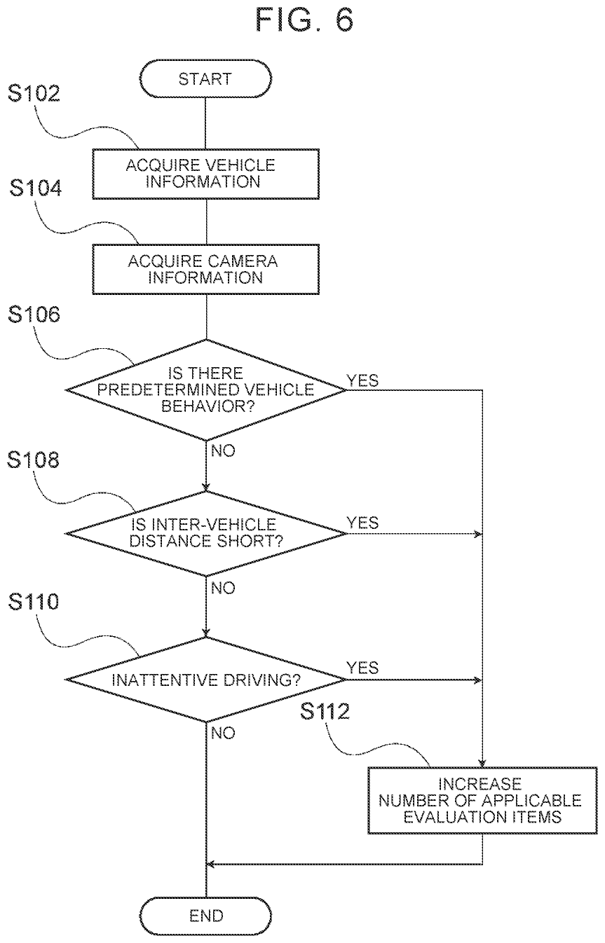

FIG. 6 is a flowchart showing an example of the flow of the driving diagnosis process by the driving diagnosis device 12. This driving diagnosis process is executed by the CPU 20 reading a program from the ROM 22 or the storage 26 and expanding it to the RAM 24.

As shown in FIG. 6, the CPU 20 acquires the vehicle information in step S102. Further, the CPU 20 acquires camera information in step S104. Specifically, the CPU 20 acquires information from sensors including the front camera 40, the indoor camera 42, the acceleration sensor 44, and the steering angle sensor 46 with the function of the acquisition unit 70.

The CPU 20 determines in step S106 whether there is a predetermined behavior with respect to the vehicle V. Specifically, when the CPU 20 detects the predetermined behavior in the vehicle V with the function of the measuring unit 72, the CPU 20 determines that there is the predetermined behavior, and proceeds to the process of step S112. The process of step S112 will be described later. The predetermined behavior referred to here is behavior such as sudden acceleration, sudden braking, sudden steering, and lane deviation.

When the CPU 20 determines in step S106 that there is not predetermined behavior with respect to the vehicle V, the CPU 20 proceeds to the process of step S108 and determines whether the inter-vehicle distance between the vehicle V and the preceding vehicle is short. Specifically, the CPU 20 measures the inter-vehicle distance between the vehicle V and the preceding vehicle based on a signal from the front camera 40 or a sensor (not shown) with the function of the measuring unit 72, and determines that the inter-vehicle distance is short when a state in which the inter-vehicle distance between the vehicle V and the preceding vehicle is shorter than a predetermined distance continues for a predetermined time or more. Then, when the CPU 20 determines in step S108 that the inter-vehicle distance is short, the CPU 20 proceeds to the process of step S112.

When it is not determined in step S108 that the inter-vehicle distance is short, the CPU 20 proceeds to the process of step S110. Similarly, when the preceding vehicle is not detected, the process proceeds to step S110. The CPU 20 determines in step S110 whether inattentive driving is performed. Specifically, the CPU 20 determines, with the function of the measuring unit 72, that the driver is performing inattentive driving, when the line-of-sight direction of the driver deviates from the traveling direction for a predetermined time or more, based on the signal from the indoor camera 42. Then, when the CPU 20 determines in step S110 that inattentive driving is being performed, the CPU 20 proceeds to the process of step S112. In contrast, when the CPU 20 determines in step S110 that inattentive driving is not performed, the CPU 20 ends the driving diagnosis process.

When an affirmative determination is made in step S106, when an affirmative determination is made in step S108, and when an affirmative determination is made in step S110, the CPU 20 moves to the process of step S112 and increases the number of measurement times. Specifically, the CPU 20 increases the number of measurement times of the corresponding evaluation item among the evaluation items, by one. For example, when it is determined in step S110 that inattentive driving is being performed, the CPU 20 increases the number of measurements of inattentive driving by one with the function of the measuring unit 72 in step S112. Then, the CPU 20 ends the driving diagnosis process.

Example of Advance Notification Process

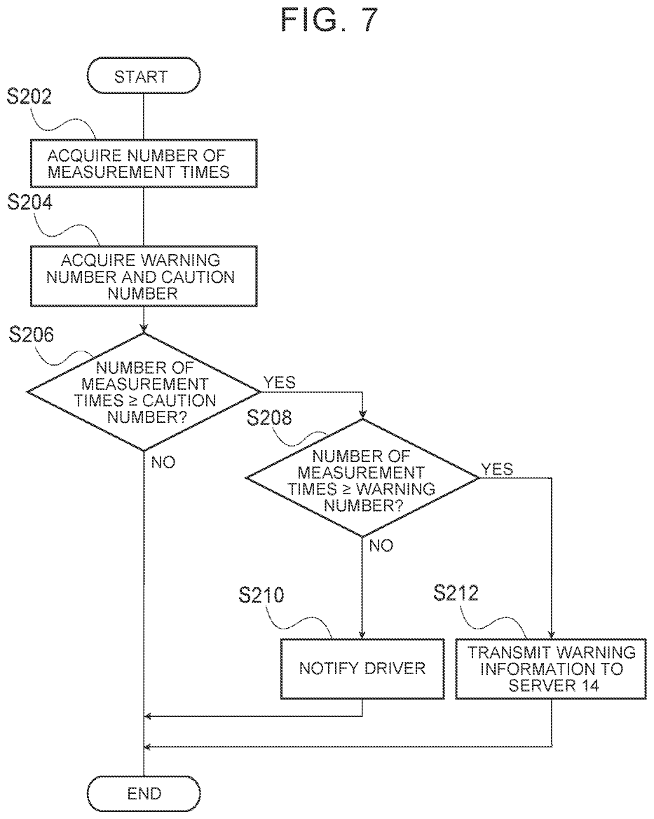

FIG. 7 is a flowchart showing an example of the flow of the advance notification process by the driving diagnosis device 12. This advance notification process is executed by the CPU 20 reading a program from the ROM 22 or the storage 26 and expanding it to the RAM 24. Further, the advance notification process is repeatedly executed at a predetermined cycle.

As shown in FIG. 7, the CPU 20 acquires the number of measurement times in step S202. Specifically, the CPU 20 acquires the number of measurement times for each of the evaluation items. Subsequently, the CPU 20 acquires the warning number and the caution number in step S204.

In step S206, the CPU 20 determines whether the number of measurement times is equal to or more than the caution number. In the present embodiment, the CPU 20 compares the number of measurement times and the caution number for each of the evaluation items. For the evaluation items in which a parameter to not issue a notification is set, the caution number is not set and thus, the number of measurement times and the caution number are not compared.

When the number of measurement times is determined to be equal to or more than the caution number in step S206, the CPU 20 proceeds to the process of step S208. Further, when the number of measurement times is less than the caution number in step S206, the CPU 20 ends the advance notification process.

In step S208, the CPU 20 determines whether the number of measurement times is equal to or more than the warning number. In the present embodiment, the CPU 20 compares the number of measurement times and the caution number for each of the evaluation items.

When the number of measurement times is determined to be equal to or more than the warning number in step S208, the CPU 20 proceeds to the process of step S212 and transmits (outputs) measurement information to the server 14 with the function of the warning unit 74. Then, the CPU 20 ends the advance notification process.

In contrast, when the number of measurement times is less than the warning number in step S208, the CPU 20 moves to the process of step S210. The CPU 20 performs advance notification to the driver in step S210. Specifically, the CPU 20 notifies the driver by displaying information on the center display 48 with the function of the advance notification unit 76. Further, the CPU 20 may notify the driver by voice from the speaker 50. Further, the CPU 20 may not give the advance notification for the evaluation items for which an advance notification has already been given.

Other Examples of Advance Notification Process

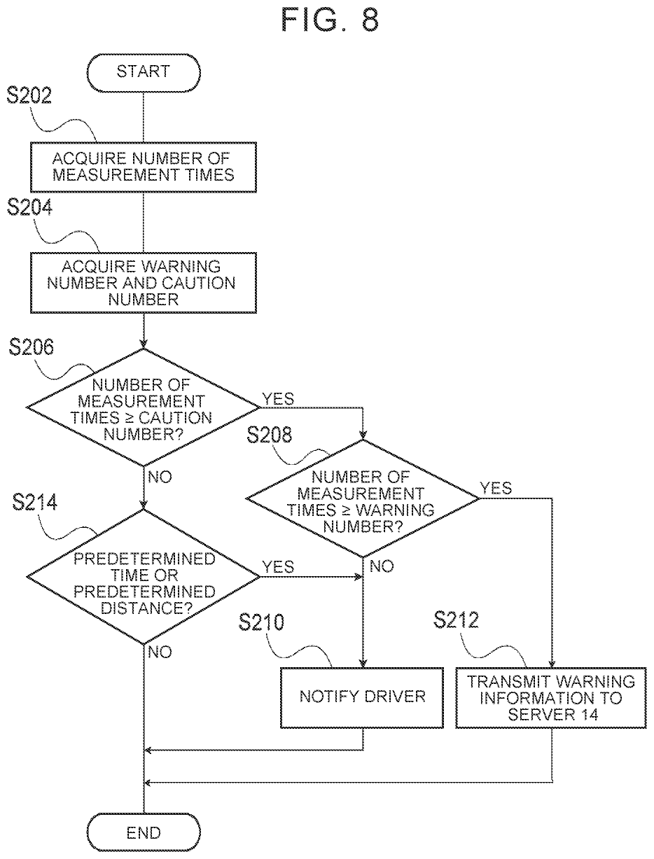

FIG. 8 is a flowchart showing another example of the flow of the advance notification process by the driving diagnosis device 12. This advance notification process is executed by the CPU 20 reading a program from the ROM 22 or the storage 26 and expanding it to the RAM 24.

The advance notification process shown in FIG. 8 differs from the advance notification process shown in FIG. 7 in that step S214 is added. Specifically, when the number of measurement times is less than the caution number in step S206, the CPU 20 moves to the process of step S214.

The CPU 20 determines in step S214 whether the time is a predetermined time or whether a distance is a predetermined traveling distance. For example, the CPU 20 acquires the current time, and when the current time is a preset time, the CPU 20 determines that the current time is a predetermined time. Further, the CPU 20 acquires the traveling distance of the vehicle V, and when the traveling distance is a preset traveling distance, the CPU 20 determines that the traveling distance is a predetermined traveling distance. Here, the predetermined time is, for example, a time when the driver plans to take a break. Further, the predetermined traveling distance is set to a distance smaller than the average traveling distance traveled during work, with the traveling distance at the start of work is set to zero. For example, the predetermined traveling distance may be set to about half of the average traveling distance traveled during work.

As described above, in the present embodiment, when the number of measurement times of one of evaluation items reaches the predetermined warning number corresponding to the one of the evaluation items, the warning unit 74 transmits the warning information to the server 14. As a result, the manager and the driver can grasp the evaluation item in which improvement in driving needs to be performed by referring to the warning information. In addition, the manager can centrally manage the warning information.

Further, in the present embodiment, when a predetermined notification condition is satisfied before the number of measurement times reaches the warning number, the advance notification unit 76 notifies the driver in advance. As a result, the driver can know the information on the number of measurement times before the number of measurement times reaches the warning number, and it is possible to promote the improvement of driving before the number of measurement times reaches the warning number. At this time, the advance notification unit 76 can perform advance notification to the driver with the center display 48 and the speaker 50 provided in the vehicle.

In particular, in the present embodiment, the driver is notified when the number of measurement times reaches the caution number. This makes it possible for the driver to know the number of times it takes to reach the warning number.

Further, in the present embodiment, even in a state before the number of measurement times reaches the caution number, the driver can grasp the driving situation by being notified of the predetermined time or traveling distance.

Furthermore, in the present embodiment, advance notification is given only for a specific evaluation item in which the notification is on, among the plurality of the evaluation items. Thus, compared to when advance notification is given to all of the evaluation items, it is possible to suppress the driver from feeling annoyed.

The driving diagnosis system 10 and the driving diagnosis device 12 according to the embodiment have been described above. It is understood that they can be implemented in various modes without departing from the scope of the present disclosure. For example, in the above embodiment, sudden acceleration and sudden braking are detected based on the signal from the acceleration sensor 44. However, the present disclosure is not limited to this. For example, an electric signal input from an accelerator pedal and a brake pedal may be acquired, and sudden acceleration and sudden braking may be detected based on this signal.

Further, in the above embodiment, the advance notification is performed for only a specific evaluation item among the evaluation items. However, the present disclosure is not limited to this. For example, advance notification may be given to all evaluation items. In this case, the technique for giving advance notification may be changed for each of the evaluation items. For example, when it is desired to further caution the driver, a caution may be displayed on the center display 48 and notification may be performed by voice, and the driver may be notified of the evaluation items having a low degree of caution by only displaying the caution on the center display 48.

Further, various processors other than the CPU 20 may execute the display process in which the CPU 20 reads and executes the program in the above embodiment. Exemplified as a processor in this case are a programmable logic device (PLD) such as a field-programmable gate array (FPGA) or the like in which a circuit configuration can be changed after manufacturing, and a dedicated electric circuit or the like that is a processor having a circuit configuration specially designed to execute a specific process such as an application specific integrated circuit (ASIC). In addition, the driving diagnosis process and the advance notification process may be executed by one of these various processors, or may be executed by a combination of two or more processors of the same type or different types. For example, the processes may be executed by a plurality of FPGAs, a combination of the CPU and the FPGA, and the like. Further, the hardware structure of these various processors is, more specifically, an electric circuit in which circuit elements such as semiconductor elements are combined.

Further, in the above embodiment, the storage 26 is configured to store various data. However, the present disclosure is not limited to this. For example, a non-temporary storage medium such as a compact disc (CD), a digital versatile disc (DVD), and a serial bus (USB) memory may be set as a storage unit. In this case, various programs, data, and the like are stored in the above storage media.

What is claimed is:

1. A driving diagnosis device comprising:
an acquisition unit that acquires at least one of vehicle information regarding a vehicle state and driving information regarding a driving state of a driver;
a measuring unit that measures the number of times each of conditions of preset evaluation items related to driving is met, based on the acquired vehicle information and the acquired driving information;
a warning unit that outputs warning information when the number of measurement times of one of the evaluation items reaches a predetermined warning number corresponding to the one of the evaluation items; and
an advance notification unit that performs advance notification to the driver when a predetermined notification condition is satisfied before the number of measurement times reaches the warning number.

2. The driving diagnosis device according to claim 1, wherein the notification condition includes a case in which the number of measurement times reaches a predetermined caution number that is less than the warning number by a predetermined number of times.

3. The driving diagnosis device according to claim 2, wherein the notification condition includes a case in which a predetermined time comes before the number of measurement times reaches the caution number.

4. The driving diagnosis device according to claim 2, wherein the notification condition includes a case in which a predetermined traveling distance is reached before the number of measurement times reaches the caution number.

5. The driving diagnosis device according to claim 1, wherein the advance notification unit performs advance notification only for a specific evaluation item among the evaluation items.

6. A driving diagnosis system comprising:
a server owned by a manager of a vehicle;
a notification device installed in the vehicle; and
the driving diagnosis device according to claim 1,
wherein the warning unit outputs warning information to the server, and
wherein the advance notification unit performs advance notification to a driver by the notification device.

7. A driving diagnosis method comprising:
acquiring at least one of vehicle information regarding a vehicle state and driving information regarding a driving state of a driver;
measuring the number of times each of conditions of preset evaluation items related to driving is met, based on the acquired vehicle information and the acquired driving information;
outputting warning information when the number of measurement times of one of the evaluation items reaches a predetermined warning number corresponding to the one of the evaluation items; and
performing advance notification to the driver when a predetermined notification condition is satisfied before the number of measurement times reaches the warning number.
